(19) United States
(12) Patent Application Publication
(10) Pub. No.: US 2008/0257800 A1
(43) Pub. Date: Oct. 23, 2008

(54) Wagering Game System With Progressive-Award Denomination Selection Feature

(76) Inventors: Mark B. Gagner, West Chicago, IL (US); Alfred Thomas, Las Vegas, NV (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/089,663

(22) PCT Filed: Oct. 10, 2005
(86) PCT No.: PCT/AU2005/001556

§ 371 Date: Jun. 4, 2008

(51) Int. Cl. E04H 4/12; C02F 1/00; E04H 4/14

(52) U.S. Cl. 210/96.1; 210/167.12

(57) ABSTRACT

A water conservation system for use with a swimming pool, said means comprising a storage reservoir (27,29 and 31) having an inlet (33) and an outlet (37), the inlet being connected to the pump outlet of the pump filter assembly of the swimming pool, the outlet being connected to the intake of the pump filter assembly inlet through a second valve, a waste outlet which is able to deliver water to a waste.

### FIELD OF THE INVENTION

This invention relates to a water conservation means which can be used with swimming pools and the like.

### BACKGROUND

A common frustration for swimming pool owners arises from the circumstance that during dry periods and in particular during Summer the rate of evaporation can be quite significant requiring the owner to regularly top-up the swimming pool. This action creates difficulties where there are restrictions in regard to the usage of water. In addition during wet periods and in particular winter months it is not uncommon for a swimming pool to overflow due to the amount of water that falls into the swimming pool and as a result the swimming pool owner must regularly dump that water in order that the filtering system of the swimming pool will operate effectively.

A further difficulty arises from the difficulty in legally dumping the water. In most cases the water being dumped has a concentration of chlorine and/or salt which is environmentally unacceptable and which has the potential to cause damage to the environment if it is delivered into the environment and it is common that the local regulations do not allow for the dumping of the water into sewers.

### DISCLOSURE OF THE INVENTION

Throughout the specification and claims the term “swimming pool”, unless the context requires otherwise, shall be taken to comprise a swimming pool or spa or ornamental pond or fish pond or like contained body of water having a pump filter assembly associated with the swimming pool whereby the pump draws water from the swimming pool causing the water to pass through a filtering arrangement and return then return to the swimming pool. It is usual that such pump filter assemblies are associated with some means for chlorinating or similarly treating the water. In addition it is usual that such pump filter assemblies will be associated with a control valve whereby the filter can be placed in a “backwash” or “rinse” mode where the water drawn from the swimming pool be dumped through a waste outlet to a sump or a like waste.

Furthermore throughout the specification and claims the term “waste”, unless the context requires otherwise, shall be taken as including a sump or a sewer or a like waste deposition site.

Furthermore throughout the specification and claims, unless the context requires otherwise, the word “comprise” or variations such as “comprises” or “comprising”, will be understood to imply the inclusion of a stated integer or group of integers but not the exclusion of any other integer or group of integers.

Accordingly the invention resides in a water conservation system for use with a swimming pool of the form described above, said means comprising a storage reservoir having an inlet and an outlet, the inlet being connected to the pump outlet of the pump filter assembly of the swimming pool, the outlet being connected to the intake of the pump filter assembly inlet through a second valve, a waste outlet which is able to deliver water to a waste.

According to a preferred feature of the invention a second filter is provided between the waste outlet and the interior of the storage reservoir. According to a preferred feature of the invention the filter is located to the exterior of the storage reservoir. According to a second embodiment of the invention the filter is located within the storage reservoir. According to a preferred feature of the second embodiment the inlet opens into the filter.

According to a preferred feature of the invention a first valve is provided between the waste outlet and the inlet to enable the delivery of water to the reservoir or to the waste outlet.

According to a preferred feature of the invention the waste outlet is provided in the storage reservoir and is located at the uppermost desired level of water within the storage reservoir.

According to a preferred feature of the invention the storage reservoir comprises a set of reservoirs. According to a preferred feature of the invention the set of reservoirs comprise more than one reservoir and the outlet of each of the reservoirs of the set of reservoirs are connected to a common outlet. According to a preferred feature of the invention the set of reservoirs comprise more than two reservoirs and the majority of the reservoirs are located above the level of the pump inlet. According to a preferred feature of the invention the waste outlet is provided in the storage reservoir and is located at the uppermost desired level of water within the reservoir most remote from the inlet.

According to an alternative preferred feature of the invention the storage reservoir is located underground and the outlet is provided with an auxiliary pump.

According to a preferred feature of the invention the storage reservoir has an overflow outlet towards its upper extent to permit the overflow of water when filled.

According to a preferred feature of the invention the inlet is connected to the storm water drains or gutters of a building to receive water therefrom.

According to a preferred feature of the invention the waste outlet comprises a waste reservoir, said outlet being connected to the waste reservoir through a third valve, a flow control provided between the waste reservoir and the waste to control the delivery of water from the waste outlet to the waste. According to preferred feature of the invention the waste reservoir is associated with a sensor adapted to measure the concentration of dissolved compounds in the water contained by the waste reservoir. According to a preferred feature of the invention the flow control is adapted to enable water in the waste reservoir when the said concentration is below a desired level.

The invention will be more fully understood in the light of the following description of several specific embodiments.

### BRIEF DESCRIPTION OF THE DRAWINGS

The description is made with reference to the accompanying drawing of which:

FIG. 1 is a schematic illustration of arrangement according to the first embodiment;

FIG. 2 is a schematic illustration of arrangement according to the second embodiment; and

FIG. 3 is a schematic illustration of arrangement according to the third embodiment.

### DETAILED DESCRIPTION OF SPECIFIC EMBODIMENTS

Each of the embodiments relates to a water conservation system which can be utilised with a swimming pool. The purpose of the arrangement is to enable the swimming pool owner to extract excess water from the swimming pool which can arise from inclement conditions and then subsequently utilise that water when it becomes necessary to top-up the swimming pool to overcome a loss of water due to evaporation or use of the swimming pool.

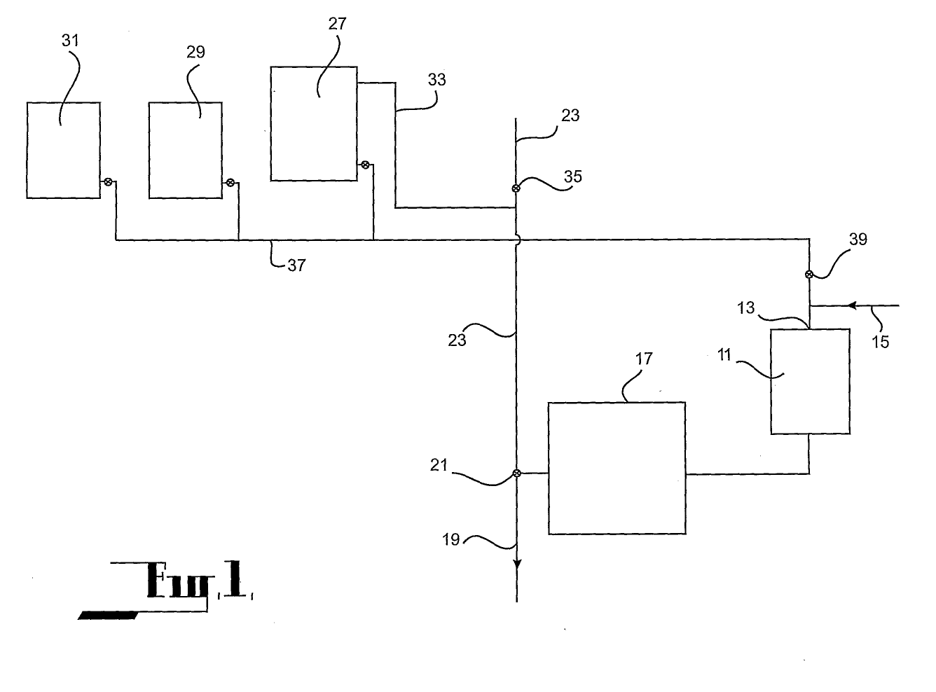

The first embodiment as shown at FIG. 1 is intended to be used in association with the pump filter assembly which is provided with the swimming pool. The assembly comprises a pump 11 which incorporates an initial pickup filter and has an inlet 13 which is connected to a fluid line 15 from the swimming pool skimmer box. The pump filter assembly further comprises a main filter 17 whereby water from the pump 11 is delivered to the main filter 17 to be returned to the swimming pool through a return line 19. In addition the pump filter assembly is provided with a control valve 21 which facilitates the filter to be backwashed whereby the backwash water is delivered to a waste line 23. In addition the control valve 21 has a “rinse” position whereby filtered water from the filter can be delivered to the waste line 23. Under normal circumstances the waste line 23 has an outlet which deposits the wastewater into a sump or into a sewer or a like waste (not shown). This situation is unsatisfactory in that it results in a wastage of water. To avoid this circumstances the first embodiment as shown at FIG. 1 comprises a conservation system which is connected to the waste line and which comprises a storage reservoir in the form of a set of three tanks 27, 29 and 31 which are located above ground with their bases generally above the level of the swimming pool. The system further comprises a bypass line 33 between the waste line 23 and an inlet at the upper portion of the first tank 27. A first valve 35 is provided in the waste line 23. The first valve 35 is able to direct waste water from the pump outlet to the waste outlet provided at the end of the waste line 23 our to the inlet of the storage reservoir through the bypass line 33. Each of the tanks are interconnected through a discharge line 37 which is connected into the lower portion of each of the tanks. The connection between the discharge line 37 and each of the tanks is controlled through a set of third valves 36, where a third valve 36 is provided for each tank. The discharge line 37 is connected to the pump inlet 13 of the pump 11 through a second valve 39.

When the swimming pool is operating according to normal conditions the second valve 39 is closed and the control valve 21 is switched to cause the filtered water from the pump filter assembly to be delivered into the return line 19 and into the swimming pool. In the event of the swimming pool containing too much water as a result of rain, the control valve 21 is switched to the “rinse” cycle position and the first valve 35 is closed. As a result water is delivered from the main filter into the bypass line 33 and then into the first tank 27. At this point in time the second valve 39 is maintained closed. Due to the presence of the common interconnection between the tanks through the discharge line 37 the water delivered into the first tank 27 will be delivered into each of the other tanks (provided that the third valves are open) such that the level in all of the tanks is substantially equal. The delivery of water into each of the tanks from the other tanks can be controlled by operation of the respective third valve 36.

When it becomes necessary to top-up the swimming pool, the second valve 39 is opened and the pump 11 is activated. As a result water is drawn from the tanks through the discharge line 37 and is delivered into the pump 11 to pass through the filter 17 and then to the swimming pool through the delivery line 19. On the desired level being attained within the swimming pool, the second valve 39 is closed.

The first embodiment provides a means whereby excess water within the swimming pool can be extracted from the swimming pool to be utilised at a later time.

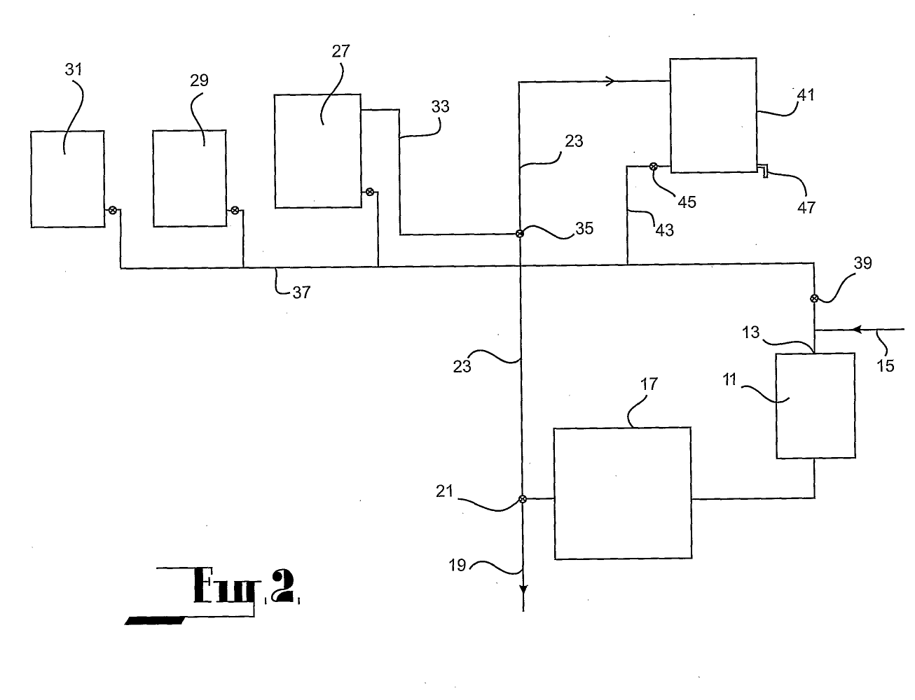

The second embodiment of the invention as shown at FIG. 2 takes the same form as the first embodiment with the exception that the waste line 23 is connected to a waste reservoir 41 and the discharge line 37 is connected to the waste reservoir through a diversion line 43 which is controlled by a fourth valve 45. The waste reservoir has an outlet which is controlled by a fifth valve 47 and is connected to the sump or sewer or a like waste. The function of the waste reservoir is to enable the water being delivered from swimming pool via the waste line 23 to be diluted by water contained in the tanks to a concentration at which the water can be legally or ethically delivered into the sump or sewer or a like waste by the opening of the fifth valve 47. The entry to the waste reservoir is provided with a screen or filter to extract larger debris from the water flowing to the waste reservoir

In addition the first valve 35 is located at the junction of the waste line 23 with the bypass line 33 of the first valve has four modes of operation in that
in one mode it can be fully closed which ensures that no water can be delivered into the storage reservoir or to the waste reservoir;
in a second mode it is open to the waste reservoir only and will allows the operator when back washing the main filter or rinsing the main filter to discharge the back wash or rinse water directly to the waste reservoir;
in a third mode it is open the storage reservoir only which enables an operator when conducting a back wash cycle or rinse cycle to cause the backwash water or rinse water to be delivered to the storage reservoir; and
in a fourth mode it is open to both the storage reservoir and the waste reservoir 23 in order that:
   when the operator is backwashing the filter or during the rinse cycle the backwash water or rinse water will flow to both reservoirs; or
   will allow water from the storage reservoir to enter the waste line to mix with the back wash water or rinse water flowing into the waste reservoir and dilute the rinse water flowing to the waste reservoir 41; or
   will allow water from the storage reservoir to enter the waste line to and flowing into the waste reservoir and dilute the contents of the waste reservoir 41.

In application whenever it is necessary to dump water from the swimming pool (e.g. during a back-wash and/or rinse cycle) the waste water can be delivered into the waste reservoir to partially fill the waste reservoir and the water stored in the tanks 27, 29 and 31 can be also added to the waste reservoir to dilute the waste water. On the water in the waste reservoir attaining a concentration of chlorine and other noxious substance which is desirable the fifth valve 47 can be opened to allow the diluted waste water to pass to the sump or sewer or like waste. Since the storage reservoir contained in the tanks will have been collected as a result of the swimming pool being filled by rain, it is expected that the water in the tanks will have a low concentration of dissolved compounds which will enable it to be used as a diluting medium. Furthermore in the case of water from a chlorinated pool it can be expected that the concentration of chlorine will diminish over time as a result of dissipation of the chlorine from solution over time. In addition the waste water from the pump outlet can be delivered to the storage reservoir.

Furthermore the waste water can be diluted on its passage to the waste reservoir when the embodiment is in the fourth mode as described above.

In addition the waste reservoir can be associated with a sensor (not shown) which is able to provide an indication of the concentration of dissolved compounds in the water contained in the waste reservoir.

According to a variation of the second embodiment the operation of the fourth and fifth valves can be rendered automatic through a suitable control where by the fourth valve will be opened initially to effect the desired dilution of the contents of the waste reservoir and the fifth valve will open to dump the contents of the waste reservoir on the contents being adequately diluted.

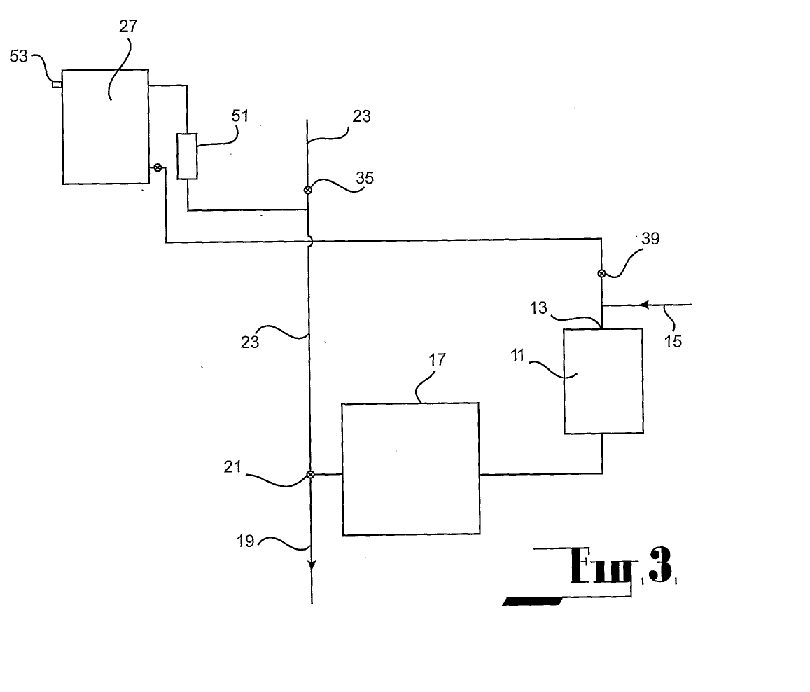

The third embodiment of FIG. 3 is a variation of the first embodiment. In the case of the third embodiment the waste line 23 is connected into the upper portion of the storage reservoir 27 and a second filter 51 is provided in the waste line 23 to remove solid particulate materials from the backwash or rinse water flowing into the storage reservoir. The storage reservoir 27 is provided with a waste outlet 53 at the uppermost desired level of water in the storage reservoir. The waste outlet is connected to the sump or sewer or a like waste. The third embodiment enables all water being dumped from the swimming pool to be filtered and then delivered into the storage reservoir 27 for subsequent return to the swimming pool when desired. On the storage reservoir 27 being filled it is anticipated that the level of dissolved chlorine will have dissipated sufficiently to enable it to be dumped into the sump or sewer or a like waste. In addition it is most likely that the need to dump water from the storage reservoir will arise as a result of the pool becoming filled due to rain. In such an instance it is anticipated the concentration of dissolved elements and compounds will have been sufficiently diluted to enable the water to be dumped into the sump or sewer or a like waste. If desired the storage reservoir 27 can comprise a set of interconnected tanks as in the case of the previous embodiments.

According to a variation of the third embodiment the filter is located within the reservoir and the inlet opens into the filter. The filter is readily able to be removed for the purposes of cleaning.

According to a further variation of the third embodiment the reservoir comprises a set of tanks as in the case of the first and second embodiment and the waste outlet 53 is provided in one of the tanks which is preferably the tank most remote from the tank accommodating the inlet.

According to fourth embodiment which is a variation of the first and second embodiments a second filter is located between the pump outlet and the interior of the storage reservoir such that it is able collect the suspended material carried in the waste water (including that being carried when the filter is being backwashed). This enables the back wash water to be collected in the reservoirs without the build-up of solid material in the storage reservoir.

According to a fifth embodiment the system of both the first, second or third embodiment can be connected to the storm water drain of a building in the vicinity of the swimming pool whereby water from the gutters can be delivered to the reservoir. This delivery can be effected by direct delivery into the reservoir or alternatively can be delivered to the inlet 13 of the pump 11.

According to a sixth embodiment the storage reservoir is located underground at a position lower than the level of the swimming pool and an auxiliary pump is provided between the reservoir and the pump inlet whereby the auxiliary pump is activated on the top-up valve 39 being opened to deliver water from the reservoir to the pump.

According to a seventh embodiment of the invention the operation of the control valve, the first and the second valve is automated and are controlled in accordance with the level of water in the swimming pool through a suitable sensor and control circuit in order that on the level of the swimming pool rising above a predetermined level the excess water is delivered to the reservoir.

It should be appreciated that the scope of the present invention need not be limited to the particular scope of the embodiments described above.

The claims defining the invention are as follows:

1. A water conservation system for use with a swimming pool of the form described above, said means comprising a storage reservoir having an inlet and an outlet, the inlet being connected to the pump outlet of the pump filter assembly of the swimming pool, the outlet being connected to the intake of the pump filter assembly inlet through a second valve, a waste outlet which is able to deliver water to a waste.

2. A water conservation system as claimed at claim 1 wherein a second filter is provided between the waste outlet and the interior of the storage reservoir.

3. A water conservation system as claimed at claim 2 wherein the filter is located to the exterior of the storage reservoir.

4. A water conservation system as claimed at claim 2 wherein the filter is located within the storage reservoir.

5. A water conservation system as claimed at claim 4 wherein the inlet opens into the filter.

6. A water conservation system as claimed at claim 1 wherein a first valve is provided between the waste outlet and the inlet to enable the delivery of water to the reservoir or to the waste outlet.

7. A water conservation system as claimed at claim 1 wherein the waste outlet is provided in the storage reservoir and is located at the uppermost desired level of water within the storage reservoir.

8. A water conservation system as claimed at claim 1 wherein the reservoir comprises a set of reservoirs.

9. A water conservation system as claimed at claim 8 wherein the set of reservoirs comprise more than one reservoir and the outlet of each of the reservoirs of the set of reservoirs are connected to a common outlet.

10. A water conservation system as claimed at claim 8 wherein the set of reservoirs comprise more than two reservoirs and the majority of the reservoirs are located above the level of the pump inlet.

11. A water conservation system as claimed at claim 8 wherein the reservoir is located underground and the outlet is provided with an auxiliary pump.

12. A water conservation system as claimed at claim 8 wherein the waste outlet is provided in the storage reservoir and is located at the uppermost desired level of water within the reservoir most remote from the inlet.

13. A water conservation system as claimed at claim 1 wherein the reservoir has an overflow outlet towards its upper extent to permit the overflow of water when filled.

14. A water conservation system as claimed at claim 1 wherein the inlet is connected to the storm water drains or gutters of a building to receive water therefrom.

15. A water conservation system as claimed at claim 1 wherein the waste outlet incorporates a waste reservoir, said outlet being connected to the waste reservoir through a third valve, a flow control provided between the waste reservoir and waste to control the delivery of water from the waste outlet to the waste.

16. A water conservation system as claimed at claim 15 wherein the waste reservoir is associated with a sensor adapted to measure the concentration of dissolved compounds in the water contained by the waste reservoir.

17. A water conservation system as claimed at claim 16 wherein the flow control is adapted to enable water in the waste reservoir on the sensor determining that the said concentration is below a desired level.

18. A water conservation system substantially as herein described with reference to the accompanying drawings.
